(19) United States
(12) Patent Application Publication
(10) Pub. No.: US 2026/0228543 A1
(43) Pub. Date: Aug. 6, 2026

(54) ARTIFICIAL INTELLIGENCE AGENTS WITH DOMAIN-SPECIFIC TASK ADAPTER LAYERS FOR LARGE LANGUAGE MODELS

(71) Applicant: Qualtrics, LLC, Provo, UT (US)

(72) Inventors: Kalyan Basu, Sammamish, WA (US); Annamalai Senthilnathan, Seattle, WA (US); Kristjan Arumae, Seattle, WA (US); Gurdeep Pall, Seattle, WA (US); Paul Mayfield, Salt Lake City, UT (US)

(21) Appl. No.: 19/044,442

(22) Filed: Feb. 3, 2025

(51) Int. Cl. G06N 3/091; G06N 3/04

(52) U.S. Cl. CPC G06N 3/091; G06N 3/04

(57) ABSTRACT

One or more embodiments described herein include an agent adaptation system that uses a centrally hosted agentic model architecture that leverages artificial intelligence models to accomplish tasks to create personalized experiences throughout a user’s product or service journey across multiple domains. Indeed, the agent adaptation system hosts and coordinates a multi-task-specific agent layer framework that receives a user prompt, extracts tasks from the prompts, and utilizes task adapter layers to generate semantic instructions to enable the task-specific agents to complete the tasks.

### BACKGROUND

Recent years have seen considerable advances in hardware and software platforms designed to deliver personalized user account experiences. For example, many traditional systems collect user account data from digital surveys, client devices, and other sources and leverage this data to target user interfaces and responses for user accounts. Additionally, some traditional systems analyze user account interactions with digital content to infer or predict user account preferences. While capable in some respects, these systems nevertheless exhibit numerous technical shortcomings that hinder their ability to seamlessly provide personalized experiences, particularly when it comes to interfacing with third-party systems securely and flexibly. Consequently, conventional systems have several limitations or disadvantages.

One limitation faced by conventional systems is inaccuracy when performing tasks for a user account. Indeed, while conventional systems implement artificial intelligence agents to autonomously execute tasks, some such systems predominantly rely on existing large language models (with billions of parameters) that are trained using enormous amounts of data across myriad topics or domains. Such overgeneralized training often results in generating results, and executing tasks, that are generic in nature, and which inaccurately focus (or which entirely lack focus) on domain-specific data. Such generalized training also frequently results in hallucinations, where an artificial intelligence agent mistakenly treats false responses or improperly executed tasks as true or proper.

Further, conventional systems are operationally inflexible. Specifically, conventional systems rely on rigid, pretrained model architectures to generate results and/or to execute tasks. For example, many existing systems use artificial intelligence agents to determine and execute computer processes, but the rigid architecture of existing models prevents them from adapting to domain-specific data, instead relying on the broad general nature of conventional large language model training. As a result, conventional systems often generate results and/or execute tasks that are too general and not well tailored to domain-specific data (e.g., relating to specific entities or companies).

Due at least in part to their inaccuracy and inflexibility, conventional systems are also inefficient. Specifically, many conventional systems require an excessive number of interactions to generate results and/or execute tasks. For instance, because existing systems use overgeneralized models that generate generic results, such systems require additional user interactions to interact with models (e.g., large language models) by providing additional prompts with more information and further instruction to continue to specify over multiple turns or iterations. Adding to these inefficiencies, some conventional systems require interacting with different artificial intelligence agents for different domains or different tasks, even when the tasks are part of the same overarching goal (e.g., one for booking flights, one for booking hotels, and one for renting cars), where each domain or task has its own application, website, and/or interface. Interacting with each of the different agents becomes navigationally expensive in terms of numbers of user interactions, requiring navigation among many interfaces and applications to accomplish the respective tasks. Processing the excessive interactions that result from such compartmentalized prior systems, as well as those that result from excessive back-and-forth communication informing the models, further results in consuming excessive computational resources (e.g., processing power and memory) that could otherwise be preserved with a more efficient system.

### SUMMARY

Embodiments of the present disclosure provide benefits and/or solve one or more of the foregoing or other problems in the art with systems, non-transitory computer-readable media, and methods that facilitate generation of responses and/or execution of tasks using task adapter layers to adapt large language models for providing knowledge to task-specific agent layers of an agentic model. For example, the disclosed systems generate and implement domain-specific task adapter layers of large language models to focus output from the large language models on generating domain-specific information to guide task-specific agent layers in executing tasks. By interfacing (and focusing) large language models with the agentic model using the task adapter layers, the disclosed systems flexibly provide seamless, personalized, holistic experiences for a user account. For example, the disclosed systems can leverage an agentic model to receive a user prompt from a client device, where the agentic model interfaces with multiple subsystems, other agentic models, and/or third-party systems on the backend to execute a series of tasks orchestrated by the agentic model which serves a single touchpoint for a user account or client device.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates an overview of the agent adaptation system utilizing an agentic model to generate a prompt response to a user prompt in accordance with one or more embodiments.

FIG. 2 illustrates an overview diagram of an agentic model utilized by the agent adaptation system in accordance with one or more embodiments.

FIG. 3 illustrates an overview of a triple-layer augmentation model and a synthetic data generation framework utilized by the agent adaptation system to augment a large language model by generating a task adapter layer in accordance with one or more embodiments.

FIGS. 4A-4B of the agent adaptation system receiving a user prompt, determining a plurality of task types and corresponding tasks from the user prompt, providing each of the one or more tasks to a task-specific agent layer, and utilizing a task adapter layer to augment the performance of each of the one or more tasks by the task-specific agent layer in accordance with one or more embodiments.

FIG. 5 illustrates an overview of a composite agentic model including a plurality of primary agent layers utilized by the agent adaptation system 100 in accordance with one or more embodiments.

FIG. 6 illustrates an example environment in which an agent adaptation system operates in accordance with one or more embodiments.

FIG. 7 illustrates an example flowchart of a series of acts for utilizing task adapter layers of a large language model augment task performance in accordance with one or more embodiments.

FIG. 8 illustrates a block diagram of an exemplary computing device in accordance with one or more embodiments.

FIG. 9 illustrates a network environment of the experience delivery system in accordance with one or more embodiments.

### DETAILED DESCRIPTION

One or more embodiments described herein include or refer to an agent adaptation system that uses a centrally hosted agentic model architecture that leverages artificial intelligence models (e.g., agentic models and large language models) to accomplish inter-platform and cross-platform tasks to create personalized experiences throughout a user’s product or service journey. Indeed, the agent adaptation system hosts, organizes, and coordinates a multi-agent framework that receives user prompts (e.g., from client device inputs or statuses received via a user interface of a client device), creates tasks from the user prompts (e.g., by dissecting a prompt into multiple, independently executable subcomponents), and interfaces with large language models augmented via task adapter layers to perform tasks.

As a general overview, the agent adaptation system can utilize an agentic model to receive the user prompts and orchestrate tasks from the user prompts. As described in further detail below, the agentic model can include or be made up of a stratified structure of sub-models, such as a primary agent layer, an orchestrator layer, multiple task-specific agent layers, and multiple task adapter layers which adapt large language models to provide knowledge to the task-specific agent layers. Specifically, the agent adaptation system can utilize an orchestrator layer of the agentic model to parse a user prompt to extract tasks from the user prompt. For instance, the agent adaptation system can utilize the orchestrator layer to determine that a user prompt describes or conveys a multi-part function or goal which is separable into sub-functions or tasks. Accordingly, the agent adaptation system can extract a series of individually executable tasks (which are discrete sub-parts, functions, or subroutines of the overall prompt) from the user prompt, some of which are implicitly, rather than explicitly, contained or described in the user prompt.

For example, the agent adaptation system can receive a user prompt requesting purchase of ingredients for a healthy dinner. The agent adaptation system can use the orchestrator layer to extract a series of tasks from the user prompt by determining that generating recommendations for a healthy dinner is a multi-part function achieved through execution of multiple functions, tasks, or processes. Using the orchestrator layer, the agent adaptation system thus extracts a first task of accessing sources for determining what types of food are “healthy,” a second task of determining what types of food are dinner items, a third task of determining a recipe which includes healthy dinner foods, a fourth task of determining ingredients for the recipe, a fifth task of determining a desired (e.g., pre-selected, preferred, or nearest) grocery store, and a sixth task of ordering the ingredients from the grocery store for the recipe. The agent adaptation system can use the orchestrator layer to assign each of the series of tasks to respective task-specific agent layers (e.g., six of them in series or in parallel). Further, the agent adaptation system can utilize task adapter layers to augment a large language model to generate semantic instructions to enable the task-specific agent layer to complete the task. In some embodiments, the semantic instruction can delineate or define computer code or a command for the task-specific agent layer to execute to complete the task. In some cases, the command can indicate a third-party entity for the task-specific agent layer to interface with to cause the task-specific agent layer to complete the task.

Continuing the healthy dinner example from above, the agent adaptation system can cause a (sixth) task-specific agent layer to receive the task of ordering ingredients from the grocery store for the recipe. The agent adaptation system can utilize a task adapter layer to augment a large language model, instructing the model to generate a semantic instruction that for determining a network-based ordering platform of a specific grocery store (e.g., a third-party entity) from which to order. The agent adaptation system can further utilize another task adapter layer to augment a large language model (e.g., the same large language model or a different large language model) to generate a semantic instruction for interacting with the ordering platform of the specific grocery store for ordering the ingredients. As generated by a large language model (augmented by a task adapter layer), a semantic instruction can include a command and/or computer code executable by a task-specific agent layer of the agentic model.

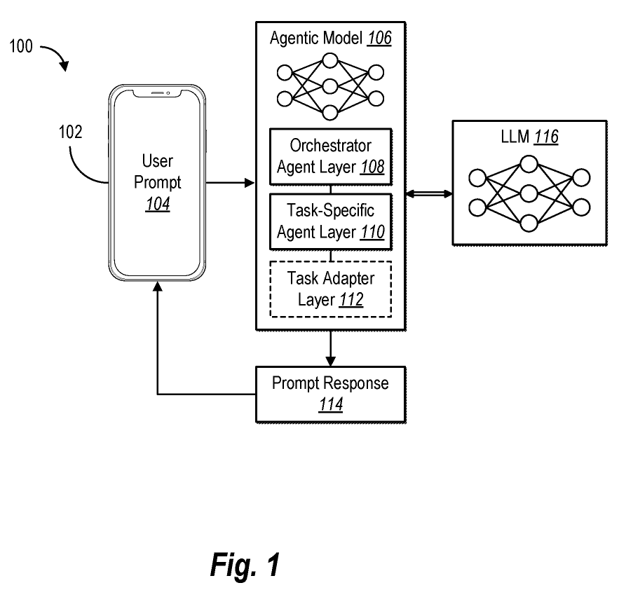

Additional detail will be provided with reference to the figures. For example, FIG. 1 illustrates an example overview of the agent adaptation system using an agentic model to dissect a user prompt and execute tasks using task-specific agent layers informed by large language model adapted to specific data domains by task adapter layers in accordance with one or more embodiments.

As shown in FIG. 1, an agent adaptation system 100 can receive a user prompt 104 through a client device 102 in accordance with one or more embodiments. The client device 102 can be associated with a user account. The user prompt 104 can be a query or an instruction or request to generate an output or to accomplish an overall objective. Further, the agent adaptation system 100 can receive the user prompt 104 through a plurality of modalities. For example, user prompt 104 can be a text input or audio input. In some embodiments, the agent adaptation system 100 can receive the user prompt 104 through a user interface and/or through a microphone.

As illustrated in FIG. 1, the agent adaptation system 100 can provide the user prompt 104 to an agentic model 106. As shown, the agentic model 106 can include an orchestrator agent layer 108 and a task-specific agent layer 110. Additionally, the task-specific agent layer 110 can be linked to a task adapter layer 112. Specifically, the task adapter layer 112 can be a layer (e.g., of computer code, semantic information, and/or instructions) augmenting a large language model (e.g., LLM 116) . Further, as indicated by the dashed lines around the task adapter layer 112, in some embodiments, the task adapter layer 112 can be a part of the agentic model 106. In some embodiments, the task-specific agent layer 110 and the task adapter layer 112 are linked, but the task adapter layer 112 is not completely a part of the agentic model 106.

The agent adaptation system 100 can utilize the orchestrator agent layer 108 to extract one or more tasks from the user prompt 104. The one or more tasks can be executable by the task-specific agent layer 110. Moreover, in some embodiments, the agent adaptation system 100 can determine that the task-specific agent layer 110 requires additional instruction to enable the task-specific agent layer 110 to complete the task in a manner that is specifically tailored to the client device 102 (and/or a user account associated with the client device 102). In addition, the agent adaptation system 100 can determine a specific domain related to the task. Responsive to this determination, the agent adaptation system 100 can cause the task-specific agent layer 110 to provide the one or more tasks to the task adapter layer 112 to cause the task adapter layer to generate a semantic instruction that includes data specific to the domain (e.g., domain-specific data to enable the task-specific agent layer 110 to perform the one or more tasks in a manner that is tailored to the user account). Indeed, the task adapter layer 112 can be a layer of (e.g., a wrapper around) the LLM 116. Specifically, the task adapter layer 112 can provide domain-specific data to the LLM 116 to enable the LLM 116 to generate a semantic instruction that includes the data specific to the domain. Additionally, the semantic instruction can include a command that is executable by the task-specific agent layer 110 to execute or perform the corresponding task.

Moreover, the agent adaptation system 100 can cause the task-specific agent layer 110 to execute the command of the semantic instruction as informed by the data specific to the domain. The agent adaptation system 100 can generate a prompt response 114 to provide an indication of an execution of the command. Indeed, the agent adaptation system 100 can generate the indication according to a type of the task corresponding to the command. For example, in some embodiments, the agent adaptation system 100 can cause the task-specific agent layer 110 to execute the command by generating the prompt response 114 to include natural language text (e.g., an answer to a query contained in the user prompt 104 or some other description related to the user prompt 104). In some embodiments the prompt response 114 can be one or more objects created or otherwise obtained through execution of the command and/or tasks (e.g., flight tickets or hotel reservations), information regarding the task (e.g., a status update), or additional information to display on the client device 102. For example, the prompt response 114 can be an indication that the agent adaptation system 100 executed one or more tasks derived from the user prompt 104 and include a hyperlink to one or more objects created by the agent adaptation system 100 as a result of executing the command, such as flight tickets.

As previously mentioned, embodiments of the agent adaptation system 100 provide several advantages over conventional systems. For instance, the agent adaptation system 100 solves the technologically rooted problem of utilizing agentic models to accurately perform series of tasks for user accounts. Indeed, the agent adaptation system 100 augments large language models by generating task adapter layers for the large language models. Specifically, the agent adaptation system 100 generates the task adapter layers utilizing domain-specific data (e.g., data specific to an entity within an industry). Accordingly, through the task adapter layers, the agent adaptation system 100 enables large language models to provide highly tailored, specific answers that enable task-specific agent layers of the agentic model 106 to seamlessly execute tasks tailored to the user account. Thus, through the task adapter layers, the agent adaptation system 100 reduces the generalization of conventional large language models, thereby also reducing hallucinations and improving accuracy in task execution.

Moreover, the agent adaptation system 100 increases the operational flexibility of conventional systems by utilizing an orchestrator layer to determine a series of tasks implicitly contained in the user prompt and orchestrating completion of the series of tasks to respond to the user prompt in a seamless, individualized manner. Indeed, through the orchestrator layer, the agent adaptation system 100 can determine the series of tasks and assign the series of tasks to corresponding task-specific agent layers, each assigned and customized to respective tasks. Unlike prior systems reliant on overgeneralized (one-size-fits-all) models, the agent adaptation system 100 thus flexibly orchestrates, adapts, and executes multiple tasks from a general (e.g., high level or multi-order) prompt without requiring explicit instructions for each individual task extracted from the prompt.

Further, through the orchestrator agent layer, the agent adaptation system 100 can enable a user account to have seamless, tailored experiences across multiple platforms. Indeed, in addition to the orchestrator layer, the agent adaptation system 100 generates and implements task adapter layers of large language models. The agent adaptation system 100 can utilize the task adapter layers to provide data transformation, customized API calls, customized semantic instruction generation, and other services that facilitate communication between the agent adaptation system 100 and multiple different services, databases, and third-party platforms. The task adapter layers, in combination with the orchestrator layer, results in increased flexibility for the agent adaptation system 100 compared to conventional systems.

Due at least in part to its improved accuracy and flexibility, the agent adaptation system 100 can provide increased efficiency compared to conventional systems. For example, the agent adaptation system 100 can provide a user interface to enable a user account to interact with a single agentic model that automatically (e.g., without user prompting) interfaces with other agentic models, systems, or platforms, to execute tasks . Responsive to receiving a user prompt, the agent adaptation system 100 utilizes (as part of an agentic model) an orchestrator layer and task-specific agent layers to identify and perform tasks, each task-specific agent layer adapted to specific domains for the discrete tasks extracted from the input prompt. Indeed, through the task-adapter layers, the agent adaptation system 100 can receive a single prompt within a single interface to extract and execute many tasks extracted from the single prompt. The agent adaptation system 100 thus reduces a number of interactions compared to prior systems, sometimes by orders of magnitude.

By consolidating the many applications, interfaces, and interactions prior systems require to execute individual, discrete tasks across different platforms into a single interface for interacting with a single agentic model, the agent adaptation system 100 not only reduces the number of interactions but also reduces computational resources (e.g., processing power and/or memory) required to process such interactions and/or facilitate simultaneous running of multiple applications or interfaces. Indeed, rather than expending excess memory by running—and caching data for—multiple domain-specific applications in tandem, the agent adaptation system 100 can reduce the running applications (and the corresponding memory consumption) to a single instance capable of performing all tasks from a single prompt in a single interface. Such improvements are especially pronounced on mobile devices where simultaneously running and interacting with multiple applications for performing separate tasks (through respective applications/agents) can be prohibitively expensive or demanding on the device, slowing performance and reducing battery life.

As illustrated by the foregoing discussion, the present disclosure utilizes a variety of terms to describe features and advantages of the agent adaptation system. Additional detail is now provided regarding the meaning of such terms. For example, as used herein, the term “agentic model” can refer to an artificial intelligence model or system of interconnected models structured to interact with a user account and perform tasks for the user account. For example, an agentic model can include, communicate with, or be made up of one or more large language models to receive, understand, and respond to user prompts. In some cases, an agentic model includes a stratified structure of sub-models or constituent layers, including: i) a primary agent layer that interfaces with a client device for receiving prompts and providing responses, ii) an orchestrator layer that interfaces with the primary agent layer model by extracting one or more tasks from prompts, and orchestrates task completion by determining task-specific agent layers that can complete a task of the one or more tasks and interfacing with the task-specific agent layers to provide tasks to the task-specific agent layers, iii) a set of one or more task-specific agent layers that interface with the orchestrator layer to receive tasks, and interface with task-adapter layers to complete the tasks in a tailored/detailed manner, and iv) a set of one or more task adapter layers (each linked to a respective task-specific agent layer) that augment large language models and enable the large language model to generate semantic instructions including data specific to a domain and a command executable by a task-specific agent layer. Indeed, an agentic model can include both conversational capabilities and task-specific functionalities to enable the agentic model to deliver personalized assistance to a user account.

Additionally, the term “large language model” refers to a set of one or more machine learning models trained to perform computer tasks to generate or identify computing code and/or data in response to trigger events (e.g., user interactions, such as text queries and/or button selections). In particular, a large language model can be a neural network (e.g., a deep neural network and/or a transformer-based neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the agent adaptation system utilizes a large language model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., semantic instructions for task-specific agent layers) based on a plurality of inputs provided to the neural network. In some cases, a neural network refers to an algorithm (or a set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a large language model.

Further, as used herein, the term “primary agent layer” can be an artificial intelligence (AI) that monitors, receives, and responds to the user prompt. Indeed, the primary agent layer can be an agentic model or a subcomponent of an agentic model that processes prompts to relay to additional agentic model components (e.g., an orchestrator layer) and that provides generated responses in return. In some cases, the primary agent layer can be a set of heuristic rules and conditions defining transitions between tasks or model states. Further, the primary agent layer can be an autonomous software program that receives user prompts, monitors the user prompts, and provides the user prompts to an orchestrator agent layer.

Relatedly, as used herein, the term “orchestrator layer” can be an AI agent, a set of heuristic rules and conditions defining transitions between tasks or model states, and/or an autonomous software program that interacts with a primary agent layer to coordinate and manage execution of multiple distributed tasks, workflows, or services (e.g., in a predefined sequence) to achieve a specific application or process goal. For example, the orchestrator agent layer can receive a user prompt from the primary agent layer, extract one or more tasks from the prompt, and orchestrate a completion of the one or more tasks by determining corresponding task-specific agent layers for each of the one or more tasks.

Further, as used herein, the term “task-specific agent layer” can be an AI agent, a set of heuristic rules and conditions defining transitions between tasks or model states, and/or an autonomous software program that interacts with an orchestrator layer and a large language model through a task adapter layer to perform or execute one or more tasks, processes, or subroutines. In some embodiments, the task-specific agent layer can receive one or more tasks from the orchestrator layer. The task-specific agent layer can autonomously determine, responsive to receiving the one or more tasks, to query the large language model (e.g., through a task adapter layer) regarding the one or more tasks. For example, the task-specific agent layer can determine (or can receive instructions from an orchestrator layer) to query its task adapter layer for semantic instructions to complete the task. In some cases, the orchestrator layer and/or the task-specific agent layer determine to incorporate a task adapter layer based on determining that, without additional semantic instruction or context, the task-specific agent layer will execute at task below a threshold level of accuracy.

In addition, as used herein, the term “task adapter layer” can refer to an augmented layer of a large language model. For example, the task adapter layer can be augmented with data specific to a domain. The task adapter layer can be a subcomponent of a triple-layer augmentation model. Additionally, the task-adapter layer can facilitate interactions between a task-specific agent layer and the LLM by enabling the LLM to generate a semantic instruction for the task-specific agent layer. In some embodiments, the task adapter layer can receive a task (or a query relating to the task) from the task-specific agent layer and can determine a first format of the task (or the query relating to the task), such as JSON or XML. The task adapter layer can convert the first format of the task (or the query relating to the task) to a second format of the task (e.g., natural language) to enable the LLM to generate a semantic instruction for the task-specific agent layer.

Further, as used, herein, the term “domain” can refer to a specific entity, such as a company or organization. Further, a domain can be a specific entity within an industry. For example, a domain can be a company within an airline industry, such as American Airlines, Delta Air Lines, United Airlines, Southwest Airlines, JetBlue Airways, Frontier Airlines, Spirit Airlines, Air Canada, WestJet, Volaris, Viva Aerobus, British Airways, Air France, Iberia, China Eastern Airlines, etc.

Moreover, as used herein, the term “semantic instruction” can refer to an instruction for a task-specific agent layer generated by a task adapter layer. The semantic instruction can include data specific to a domain and can further include a command executable by the task-specific agent layer to enable the task-specific agent layer to execute a task. For example, the semantic instruction can include data specifying information about the domain and/or preferences or other information linking a user account to a domain. Further, the semantic instruction can include a command executable according to the preferences or information linking the user account to the domain.

As used herein, the term “triple-layer augmentation model” refers to a set of multiple (e.g., three) augmentation layers that can be added to, and that an augment operation of, a large language model. Indeed, the triple-layer augmentation model can be made up of successive layers (e.g., such as wrapper layers) added to the LLM in a progressive manner where each layer builds on, and narrows the data of, the previous layer(s). Indeed, each successive layer added to the LLM can be more narrowly tailored than a previously added layer. Further, the agent adaptation system 100 can utilize the layers of the triple-layer augmentation model 310 to enable the LLM to perform pre-processing on a prompt received by the LLM to modify or otherwise tailor the prompt to cause the LLM (through the triple-layer augmentation model) to generate a response including data specific to a domain. Additionally, the agent adaptation system 100 can utilize the layers of the triple-layer augmentation model to perform post-processing on the response to modify and/or tailor the response to include data specific to the domain.

Moreover, as used herein, the term “synthetic data generation framework” refers to software that generates, synthesizes, or otherwise creates a fine-tuning dataset for training or tuning a task adapter layer (and/or a triple-layer augmentation model). For example, the agent adaptation system 100 can determine a first group of parameters from a first group of fine-tuning prompts. Further, the agent adaptation system 100 can generate the fine-tuning dataset from the first group of parameters. For example, the agent adaptation system 100 can utilize the synthetic data generation framework to generate the fine-tuning dataset to model a scenario or a group of scenarios for the LLM to respond to utilizing the triple-layer augmentation model. Indeed, the agent adaptation system 100 can generate the fine-tuning dataset to model a group of scenarios that requires data specific to a domain within an industry.

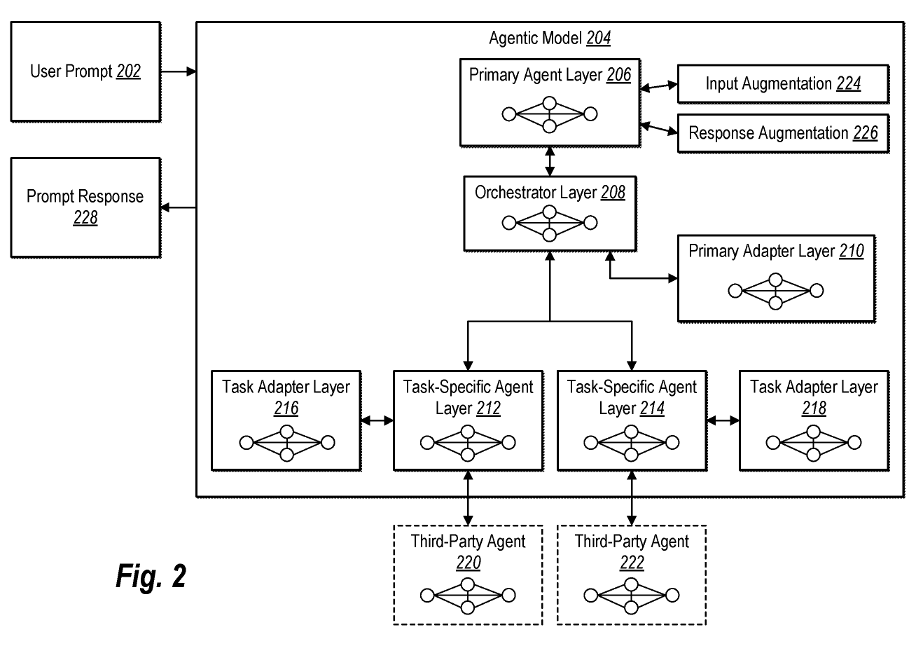

As previously mentioned, the agent adaptation system 100 can utilize an agentic model to receive a user prompt, extract one or more tasks from the user prompt, and execute the one or more tasks. For instance, the agent adaptation system 100 can use task-specific agent layers informed by task adapter layers (or large language models modified by task adapter layers). As shown in FIG. 2, the agent adaptation system 100 can implement an agentic model 204 to execute one or more tasks and to generate a prompt response in accordance with one or more embodiments.

As illustrated in FIG. 2, the agent adaptation system 100 can receive a user prompt 202 (e.g., the user prompt 104 of FIG. 1). As previously discussed, the agent adaptation system 100 can receive the user prompt 202 through a user interface (e.g., of a client device). Additionally, the agent adaptation system 100 can receive the user prompt 202 through a plurality of modalities (e.g., as text or audio, among others). The agent adaptation system 100 can provide the user prompt 202 to an agentic model 204, whereupon the agentic model 204 executes one or more tasks to generate a prompt response 228.

As illustrated in FIG. 2, the agent adaptation system 100 can provide the user prompt 202 to a primary agent layer 206 within the agentic model 204. Indeed, the agent adaptation system 100 can cause the primary agent layer 206 to monitor the user prompt 202 by performing input augmentation 224 on the user prompt 202. For example, the agent adaptation system 100 can perform input augmentation 224 monitoring the user prompt 202 for security threats, such as jailbreaks (e.g., direct or indirect prompt injection attacks, context manipulation such as role-playing or chain of prompts, model confusion such as ambiguous prompts or prompt overloading).

As shown in FIG. 2, responsive to performing input augmentation 224 on the user prompt 202, the agent adaptation system 100 can provide the user prompt 202 (or an augmented or otherwise modified version of the user prompt 202) to an orchestrator layer 208. Indeed, the agent adaptation system 100 can cause the orchestrator layer 208 to extract one or more tasks from the user prompt 202. Additionally, in some embodiments, the agent adaptation system 100 can determine one or more topics of the user prompt 202 and determine the one or more tasks according to the topic. In some embodiments, the agent adaptation system 100 can determine the one or more tasks by implying or otherwise deriving the one or more tasks from the user prompt 202.

In some embodiments, the agent adaptation system 100 can adapt the orchestrator layer 208 to the user prompt 202 using a primary adapter layer 210. Indeed, the agent adaptation system 100 can use the primary adapter layer 210 adapt a large language model generate semantic instructions guiding the orchestrator layer 208 to extract the one or more tasks from the user prompt 202 and to assign the tasks to appropriate task-specific agent layers. Indeed, in some embodiments, the agent adaptation system 100 can utilize the primary adapter layer 210 to provide the orchestrator layer 208 with contextual information (as generated by a large language model) about the user prompt. For example, responsive to determining that the user prompted 202 includes a phrase such as “my family,” the agent adaptation system 100 can use the primary adapter layer 210 to generate a prompt for a large language model based on the user prompt (and/or based on extracted tasks). Accordingly, the agent adaptation system 100 instructs the large language model to generate semantic instructions specific to the orchestrator layer 208, informing the orchestrator layer 208 how to assign the extracted tasks (e.g., which task-specific agent layer to assign to each task).

Accordingly, continuing the “my family” example, the agent adaptation system 100 provides contextual information to the orchestrator layer 208 pertaining to family members of the user account (e.g., by identifying data and/or additional user accounts indicative of a familial relationship). In some embodiments, the agent adaptation system 100 can utilize the primary adapter layer 210 to provide the orchestrator layer 208 with information regarding task-specific agent layers that are capable of performing tasks of the one or more tasks that the agent adaptation system 100 extracts from the user prompt 202 (e.g., the agent adaptation system 100 can cause the orchestrator layer 208 to extract one or more tasks from the user prompt 202 and then submit a query to the primary adapter layer 210 inquiring about task-specific agent layers that can perform at least one task of the one or more tasks with at least threshold level of accuracy).

As shown in FIG. 2, responsive to extracting the one or more tasks from the user prompt 202, the agent adaptation system 100 can determine (using the orchestrator layer 208) a task-specific agent layer (e.g., a task-specific agent layer 212 and/or a task-specific agent layer 214) as a target or destination of a task. The agent adaptation system 100 can further use the orchestrator layer 208 to provide or distribute tasks to respective task-specific agent layers.

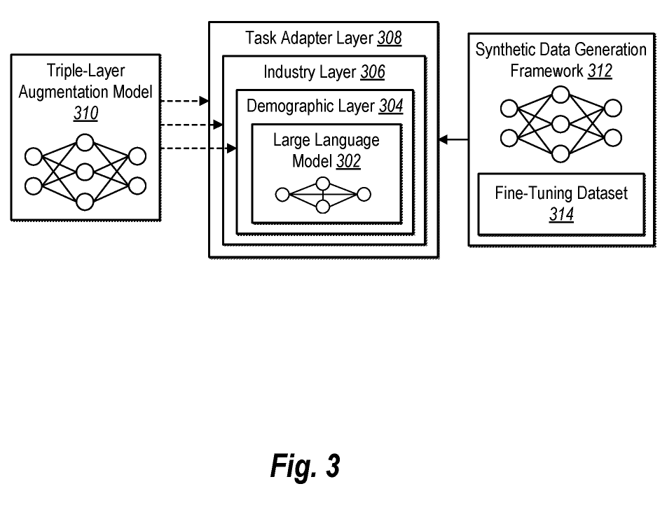

For instance, the agent adaptation system 100 provides a first task to the task-specific agent layer 212 and a second task to the task-specific agent layer 214. In addition, the agent adaptation system 100 can generate and provide data or instructions to a task adapter layer 216 and a task adapter layer 218 specific to their corresponding task-specific agent layers and/or an assigned task. In some cases, the agent adaptation system 100 can cause a task-specific agent layer (e.g., the task-specific agent layer 212 and/or the task-specific agent layer 214) to provide the task to a task adapter layer (e.g., a task adapter layer 216 and/or a task adapter layer 218). From the data or instructions to the task adapter layers, the agent adaptation system 100 can cause the task adapter layers (as modifiers of a large language model) to generate semantic instructions enabling the task-specific agent layers to complete the assigned tasks. For example, the agent adaptation system 100 can use the task adapter layer 216 to interface with a large language model, focusing the large language model on a particular domain to thereby generate a semantic instruction (e.g., computer code executable by the task-specific agent layer 212) including data specific to a domain (e.g., an entity or company) and specific to the task. More information regarding task adapter layers is provided below with respect to FIG. 3.

Further, as shown in FIG. 2, in some embodiments, the agent adaptation system 100 can cause task-specific agent layers (e.g., the task-specific agent layer 212 and/or the task-specific agent layer 214) to interface with or otherwise interact with third-party platform agents (e.g., a third-party agent 220 or a third-party agent 222) to cause the third-party agents to complete (all or part of) respective tasks. The third-party platform agents can be an artificial intelligence agent or other software, such as a set of heuristic rules and conditions defining interactions with user accounts hosted on a third-party server or a third-party cloud environment. The third-party platform agents can be specific to the domain identified by the task adapter layer 216 or the task adapter layer 218 (e.g., a third-party intelligence agent of a specific domain). As indicated by the dashed lines around the third-party agent 220 and the third-party agent 222, in some embodiments, the agent adaptation system 100 can cause the task-specific agent layer 212 to complete the task (e.g., by performing an action unique to the domain, such as purchasing a ticket or booking a reservation). In some embodiments, the agent adaptation system 100 can cause the task-specific agent layer 212 to complete the task without involving the third-party platform agent.

Further, as shown in FIG. 2, responsive to completing the task, the agent adaptation system 100 can generate a prompt response 228. The prompt response 228 include a semantic indication of a completion of the task (e.g., an update to provide to the user account regarding the task). In some embodiments, the prompt response can include an indication of any tasks performed by the third-party agent (e.g., such as a digital copy of a ticket, reservation, or receipt).

Additionally, as shown in FIG. 2, prior to providing the prompt response 228 to the client device (e.g., through a user interface), the agent adaptation system 100 can cause the primary agent layer 206 perform response augmentation 226 on the prompt response 228. For example, as a part of the response augmentation 226, the agent adaptation system 100 can cause the primary agent layer 206 to monitor the prompt response to remove any harmful or incorrect information from the prompt response 228. Indeed, the agent adaptation system 100 can perform response augmentation 226 by monitoring the monitoring the prompt response 228 for any harmful or otherwise incorrect information present in the prompt response 228 due to malicious attacks present in the user prompt 202. For example, the agent adaptation system 100 can perform response augmentation 226 by monitoring the prompt response 228 according to a set of security protocols, such as a third-party set of security protocols or an internal set of security protocols determined by the agent adaptation system 100. Additionally, the agent adaptation system 100 can perform response augmentation 226 by monitoring the prompt response 228 for inaccuracies, such as hallucination, present in the prompt response 228.

In one or more embodiments, the agent adaptation system 100 can utilize a triple-layer augmentation model to augment a large language model. In particular, the agent adaptation system 100 utilizes a triple-layer augmentation model that includes a demographic layer 304, an industry layer 306, and a task adapter layer 308. FIG. 3 illustrates an example diagram of utilizing a triple-layer augmentation model to focus a large language model on specific domain data in accordance with one or more embodiments.

Indeed, as shown in FIG. 3, the agent adaptation system 100 can utilize layers (e.g., the demographic layer 304, the industry layer 306, and/or the task adapter layer 308) of a triple-layer augmentation model 310 to enable the LLM 302 to generate increasingly specific responses to prompts. As shown, the agent adaptation system 100 can generate a first layer of the triple-layer augmentation model 310 by adding a demographic layer 304 to the LLM 302. Specifically, the agent adaptation system 100 can generate the demographic layer 304 by wrapping a first layer around the LLM 302. The demographic layer 304 can include, or be configured to extract and provide (for conditioning the large language model 302), data from a plurality of user profiles that includes biographic information for the user profiles, demographic information for the user profiles, behavioral information for the user profiles, social information for the user profiles, as well as additional types of descriptive information for the user profiles, such as work experience, educational history, hobbies or preferences, interests, affinities, or geographic location. Indeed, the agent adaptation system 100 can cause the demographic layer 304 to perform input preprocessing (e.g., by enriching the input with data from the demographic layer 304) on an input, such as a user prompt, received by the LLM 302, as well as output postprocessing (e.g., adjusting an output of the LLM 302 based on the data from the demographic layer 304) on an output of the LLM 302, such as a semantic instruction.

As illustrated in FIG. 3, the agent adaptation system 100 can generate a second layer of the triple-layer augmentation model 310 by adding an industry layer 306 on top of the demographic layer 304 (e.g., adding the industry layer 306 by wrapping the industry layer 306 around the demographic layer 304). Indeed, the agent adaptation system 100 can generate the industry layer 306 to include, or be configured to extract and provide (for conditioning the large language model 302), preference and/or experience data within an industry (e.g., a commercial industry and/or a consumer industry), such as an airline industry, a performance industry. Indeed, through the industry layer 306, the agent adaptation system 100 can perform further preprocessing on inputs that the agent adaptation system 100 provides to the LLM 302, as well as further output postprocessing on an output the agent adaptation system 100 causes the LLM 302 to tailor the input and output utilizing both the demographic layer 304 and the industry layer 306.

Moreover, as shown in FIG. 3, the agent adaptation system 100 can generate a third layer of the triple-layer augmentation model 310 by adding a task adapter layer 308 to the LLM 302.(e.g., the task adapter layer 216 or 218 of FIG. 2).To illustrate, the agent adaptation system 100 can add the task adapter layer 308 by wrapping the task adapter layer 308 around the industry layer 306. Indeed, the agent adaptation system 100 can generate the task adapter layer 308 to include, or be configured to extract and provide (for conditioning the large language model 302), data specific to a domain (e.g., an entity) within an industry (e.g., a domain of the industry layer 306). Through the task adapter layer 308, the agent adaptation system 100 can perform additional preprocessing on an input to the LLM 302 and additional postprocessing on an output of the LLM 302 utilizing the demographic layer 304, the industry layer 306, and the task adapter layer 308.

Indeed, as shown, the agent adaptation system 100 can utilize the triple-layer augmentation model 310 to augment (e.g., through preprocessing at each layer) inputs and outputs of the LLM 302 with increasing levels of detail and personalization at each layer. For example, the agent adaptation system 100 can cause the LLM 302 receive an input (e.g., a task). The agent adaptation system 100 can cause the LLM 302 to generate a first preprocessed input by processing the input utilizing the demographic layer 304. Responsive to generating the first preprocessed input, the agent adaptation system 100 can cause the LLM 302 to generate a second preprocessed input by preprocessing the first preprocessed input utilizing the industry layer 306. Responsive to generating the second preprocessed input, the agent adaptation system 100 can cause the LLM 302 to generate a third preprocessed input by preprocessing the second preprocessing input utilizing the task adapter layer 308.

Responsive to generating the third preprocessed input, the agent adaptation system 100 can cause the LLM 302 to generate an output (e.g., a response) to the third preprocessed input. The agent adaptation system 100 can utilize the demographic layer 304 to modify the output to generate a first postprocessed output. Responsive to generating the first postprocessed output, the agent adaptation system 100 can utilize the industry layer 306 to generate a second postprocessed output. Responsive to generating the second postprocessed output, the agent adaptation system 100 can utilize the task adapter layer 308 to generate a third postprocessed output. Indeed, as discussed, the agent adaptation system 100 can utilize the triple-layer augmentation model 310 to generate highly specified, tailored, unique semantic instructions that include data specific to a domain (e.g., a domain of an industry). The agent adaptation system 100 can cause the LLM 302 to provide the semantic instruction to a task-specific agent layer to enable the task-specific agent layer to enable the task-specific agent layer to perform a task in a manner that is highly specified, tailored, and unique to a user prompt received by the agent adaptation system 100.

For example, in some embodiments, the agent adaptation system 100 can utilize layers of the triple-layer augmentation model 310 to preprocess an input to the LLM 302 by formatting or otherwise utilizing prompt engineering techniques to structure the input to the LLM 302 in a way that will enable the LLM to utilize the triple-layer augmentation model to generate a tailored response to the input. Further, the agent adaptation system 100 can preprocess the input to the LLM 302 by utilizing embedding enhancements to augment inputs with contextual or external data (e.g., data from layers of the triple-layer augmentation model 310. Further, the agent adaptation system 100 can preprocess the input to the LLM 302 by utilizing data from the triple-layer augmentation model 310 to integrate user-account specific preferences, conversational history, or domain-specific knowledge into the input into the LLM 302.

Moreover, in some embodiments, the agent adaptation system 100 can utilize the triple-layer augmentation model 310 to post-process an output of the LLM 302. Indeed, the agent adaptation system 100 can utilize data from the layers of the triple-layer augmentation model to refine, contextualize, and/or personalize the output of the LLM 302. For example, the agent adaptation system 100 can utilize the triple-layer augmentation model 310 to reformat components of the output of the LLM 302, such as a semantic instruction and/or a command), according to specific requirements or needs of a task-specific agent layer.

Additionally, as shown in FIG. 3, the agent adaptation system 100 can utilize a synthetic data generation framework 312 to generate a fine-tuning dataset 314 that encapsulates or mimics scenarios within a domain of an industry. For example, the agent adaptation system 100 can generate the fine-tuning dataset 314 to cause the LLM 302 to utilize the demographic layer, 304, the industry layer 306, and the task adapter layer 308 to generate responses to scenarios that include domain-specific data.

For example, in some embodiments, the agent adaptation system 100 can generate the fine-tuning dataset 314 by parsing an existing dataset, such as a training dataset, and extract a subset of the existing dataset according to the first group of parameters. Additionally, in some embodiments, the agent adaptation system 100 can further modify the subset according to the first group of parameters to generate the fine-tuning dataset 314.

As shown in FIG. 3, the agent adaptation system 100 can provide the fine-tuning dataset 314 to the LLM 302 as an input to cause the LLM 302 to simulate the LLM 302 receiving one or more tasks according to the first group of the parameters. The agent adaptation system 100 can cause the LLM 302 to generate a response to the input. Responsive to the LLM 302 generating the response, the agent adaptation system 100 can modify one or more parameters of the task adapter layer 308 (and/or the industry layer 306, and/or the demographic layer 304) to increase an accuracy of a response generated by the LLM 302 (e.g., by utilizing the demographic layer 304, the industry layer 306, and the task adapter layer 308) to preprocess inputs and postprocess outputs of the LLM 302. Indeed, in some embodiments, the agent adaptation system 100 can cause the synthetic data generation framework 312 to iteratively generate and/or modify the fine-tuning dataset and provide the fine-tuning dataset to the LLM 302 until a response generated by the LLM 302 is above a threshold level of accuracy. Additionally, in some embodiments, the agent adaptation system 100 can provide the input to the LLM 302 by providing the input to the task adapter layer 308.

Further, in some embodiments, the agent adaptation system 100 can generate a plurality of demographic layers for the LLM 302. Additionally, for each of the plurality of demographic layers, the agent adaptation system 100 can generate a plurality of industry layers. Moreover, for each of the plurality of industry layers, the agent adaptation system 100 can generate a plurality of task adapter layers. For example, the agent adaptation system 100 can generate a first demographic layer and a second demographic layer. Further, the agent adaptation system 100 can generate a first industry layer and a second industry layer for the first demographic layer, and a third industry layer and a fourth industry layer for the second demographic layer. In addition, the agent adaptation system 100 can generate a first task adapter layer and a second task adapter layer for the first industry layer, a third task adapter layer and a fourth task adapter layer for the second industry layer, a fifth task adapter layer and a sixth task adapter layer for the third industry layer, and a seventh task adapter layer and an eighth task adapter layer for the fourth industry layer.

Additionally, in some embodiments, the agent adaptation system 100 can generate an augmented layer of the LLM 302, such as a primary adapter layer (e.g., the primary adapter layer 210 of FIG. 2), utilizing data specific to a user account. For example, the agent adaptation system 100 can generate the primary adapter layer from personal data and/or historical information of a user account, such as personal preferences and personal information.

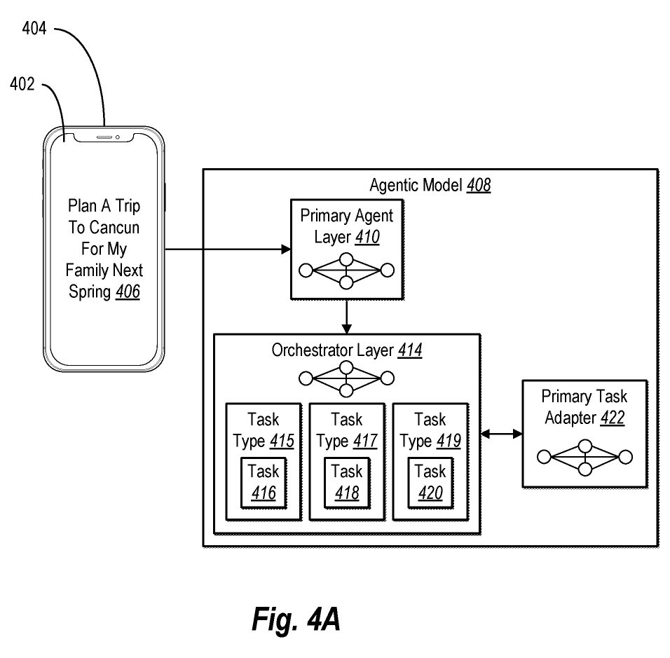

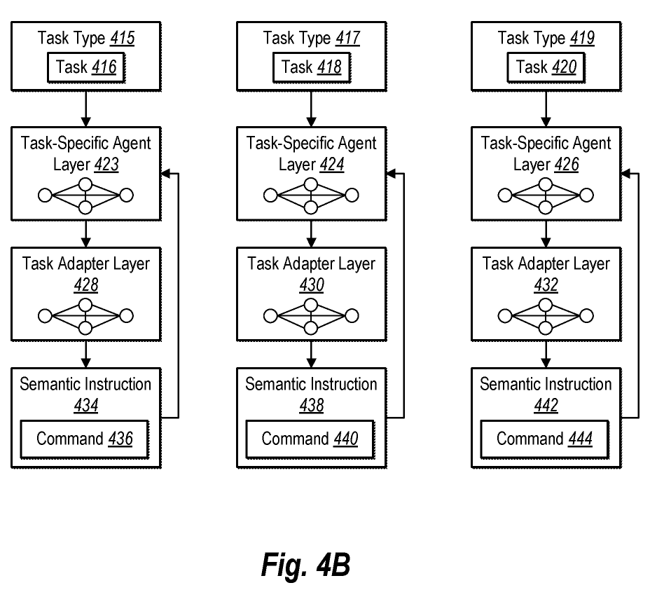

In some embodiments the agent adaptation system 100 can determine an objective from a user prompt. The objective can be an overall goal for the agent adaptation system 100 to accomplish. Further, the agent adaptation system 100 can determine task types from a user prompt according to the objective of the user prompt. In some cases, a task type includes or refers to a category or label of an individual (extracted) task indicating an output format (e.g., a filetype, a data type, and/or an indication of whether the output is a final output for presentation via a client device or an intermediate output to be processed as input for another task-specific agent layer), a data classification of input data used to generate an output, and/or a combination thereof. The plurality of task types can be implicit or explicit requirements for the agent adaptation system 100 to complete the objective. In particular, the agent adaptation system 100 can determine task types that indicate labels, classifications, or categories of processes executed to accomplish, and/or outputs generated from, various tasks. FIGS. 4A-4B illustrate the agent adaptation system 100 receiving a user prompt, determining an objective from the user prompt, determining a plurality of task types and corresponding tasks from the user prompt according to the objective, and orchestrating execution of the corresponding tasks according to their respective task types in accordance with one or more embodiments.

As illustrated in FIG. 4A the agent adaptation system 100 can receive a user prompt 406 through a user interface 402 of a client device 404. For example, the user prompt 406 can be a request for the agent adaptation system 100 to “Plan a trip to Cancun for my family next spring.” As shown, the agent adaptation system 100 can provide the user prompt 406 to an agentic model 408. The agent adaptation system 100 can cause a primary agent layer 410 of the agentic model 408 to receive the user prompt 406 and monitor the user prompt 406 for any security threats (e.g., the agent adaptation system 100 can cause the primary agent layer 410 to detect and remove any security threats from the user prompt 406).

As shown in FIG. 4A, the agent adaptation system 100 can cause the primary agent layer 410 to provide the user prompt 406 to an orchestrator layer 414. The agent adaptation system 100 can utilize the orchestrator layer 414 to determine an objective (e.g., “plan a vacation,”) and delimit a plurality of task types (e.g., a task type 415, a task type 417, and a task type 419) from the user prompt 406. Indeed, in some embodiments, the agent adaptation system 100 can cause the orchestrator layer 414 to determine a plurality of key elements from the user prompt 406 and can determine the plurality of task types according to the plurality of key elements. For example, from the user prompt 406, the agent adaptation system 100 can determine that key elements within the user prompt 406 are “trip to Cancun,” “my family,” and “next spring.” Accordingly, the agent adaptation system 100 can determine the task type 415 is “travel plans” according to the “trip to Cancun” key element. Further, the agent adaptation system 100 can determine the task type 417 is “determine participants” according to the “my family” key element. Moreover, the agent adaptation system 100 can determine the task type 419 is “determine timeline” according to the “next spring” key element.

Moreover, as illustrated in FIG. 4A, the agent adaptation system 100 can cause the orchestrator layer 414 to interface with a primary task adapter 422 (e.g., an augmented layer of an LLM as discussed above with respect to FIG. 3) to determine one or more tasks of each task type, as well an order of completion of the task types and/or one or more tasks. Indeed, the agent adaptation system 100 can utilize the orchestrator layer 414 and the primary task adapter 422 to determine to perform tasks of various task types and/or in series and/or in parallel. In some cases, the agent adaptation system 100 can determine tasks that are parallelly executable (e.g., do not rely on the output of one another) and can execute such tasks in parallel using respective task-specific agent layers. For example, the agent adaptation system 100 can provide the task type 415 (e.g., travel plans), the task type 417 (e.g., determine participants) and the task type 419 (e.g., determine timeline) to the primary task adapter 422. The agent adaptation system 100 can cause the primary task adapter 422 to determine an order of completion of tasks relating to the plurality of task types by determining a relative level of independence for each of the plurality of task types and/or tasks.

For example, the agent adaptation system 100 can cause the primary task adapter 422 to determine that the task type 415 (e.g., determine travel plans) has a low level of independence compared to the task type 417 (e.g., determine participants) and the task type 419 (e.g., determine timeline) because the task type 415 depends on the task type 417 and 419 (e.g., travel plans require a timeline and participants). Further, the agent adaptation system 100 can cause the primary task adapter 422 to determine that the task type 417 (e.g., determine participants) has a high level of independence compared to the task type 415 and the task type 419 because the participants of the trip do not depend on any other factors. Additionally, the agent adaptation system 100 can cause the primary task adapter 422 to determine that the task type 419 (e.g., determine timeline) has an intermediate level of independence relative to the task type 415 and the task type 417 because the task type 419 depends on the task type 417. Accordingly, the agent adaptation system 100 can determine an order of operations for the plurality task types.

Additionally, the agent adaptation system 100 can utilize the orchestrator layer 414 and the primary task adapter 422 to determine one or more tasks for each of the plurality of task types according to the order of completion for the plurality of task types. For example, responsive to determining the task type 417, the agent adaptation system 100 can determine a task 418 corresponding to the task type 417 of confirming participants (e.g., family members) that will attend the family vacation to Cancun. Further, responsive to determining the task type 419 of determining a timeline (and in some embodiments, responsive to executing one or more tasks according to the order of operations for the plurality of task types), the agent adaptation system 100 can determine a task 420 corresponding to the task type 419 of confirming a timeline for the vacation. Moreover, responsive to determining the task type 415 of confirming or otherwise acquiring travel plans for participants within the constraints of the timeline.

As shown in FIG. 4B, responsive to determining the task 416 according to the task type 415, the task 418 according to the task type 417, and the task 420 according to the task type 419, the agent adaptation system 100 can determine a corresponding task-specific agent layer of the one or more task-specific agent layers to provide each task to. For example, the agent adaptation system 100 can provide the task 416 to a task-specific agent layer 423, the task 418 to a task-specific agent layer 424, and the task 420 to a task-specific agent layer 426.

Moreover, as illustrated in FIG. 4B, the agent adaptation system 100 can cause each of the task-specific agent layers to interface with respective task adapter layers to generate a semantic instruction including a command executable by the task-specific agent layers to enable the task-specific agent layers to perform the tasks. For example, the agent adaptation system 100 can cause the task-specific agent layer 423 to provide the task 416 to the task adapter layer 428. Responsive to the task adapter layer 428 receiving the task 416, the agent adaptation system 100 can cause the task adapter layer 428 to generate a semantic instruction 434 that includes a command 436 executable by the task-specific agent layer 423 to enable the task-specific agent layer 423 to execute the task at or above a first threshold level of accuracy.

Additionally, the agent adaptation system 100 can cause the task-specific agent layer 424 to provide the task 418 to the task adapter layer 430. Responsive to the task adapter layer 430 receiving the task 418, the agent adaptation system 100 can cause the task adapter layer 430 to generate a semantic instruction 438 that includes a command 440 executable by the task-specific agent layer 424 to enable the task-specific agent layer 424 to execute the task at or above a second threshold level of accuracy. Further, the agent adaptation system 100 can cause the task-specific agent layer 426 to provide the task 420 to the task adapter layer 432.

Responsive to the task adapter layer 432 receiving the task 420, the agent adaptation system 100 can cause the task adapter layer 432 to generate a semantic instruction 442 that includes a command 444 executable by the task-specific agent layer 426 to enable the task-specific agent layer 426 to execute the task at or above a third threshold level of accuracy. Indeed, the agent adaptation system 100 can determine a threshold level of accuracy required for a task-specific agent layer according to a type of the task.

Indeed, in some embodiments, the agent adaptation system 100 can cause a task adapter layer (e.g., the task adapter layer 428, the task adapter layer 430, and/or the task adapter layer 432) to generate a semantic instruction (e.g., the semantic instruction 434, the semantic instruction 438, and/or the semantic instruction 442) including a command (e.g., the command 436, the command 440, and/or the command 444) for the task-specific agent layer (e.g., the task-specific agent layer 423, the task-specific agent layer 424, the task-specific agent layer 426) to request a confirmation from a user account and/or more information regarding a task. For example, the agent adaptation system 100 can cause the task adapter layer 430 to generate the semantic instruction 438 for the task-specific agent layer 424 to generate a list of participants in the vacation that includes the command 440 (e.g., computer code) executable by the task-specific agent layer 424 to cause the task-specific agent layer 424 to generate a prompt response that includes a list of the participants for the agent adaptation system 100 to display in a user interface (e.g., the user interface 402 of FIG. 4A). Further, the agent adaptation system 100 can generate the command 440 to include a request of a confirmation, via the graphical user interface, of the list of participants.

Similarly, the agent adaptation system 100 can cause the task adapter layer 432 to generate the semantic instruction 442 for the task-specific agent layer 426 to generate a timeline for the vacation that includes the command 444 (e.g., computer code) executable by the task-specific agent layer 426 to cause the task-specific agent layer 426 to generate a prompt response that includes the timeline for the vacation for the agent adaptation system 100 to display in the user interface. Further, the agent adaptation system 100 can generate the command 444 to include a request of a confirmation via the graphical user interface, of the timeline.

Moreover, in some embodiments, the agent adaptation system 100 can determine that a task comprises a plurality of sub-tasks. For example, the agent adaptation system 100 can determine that the task 416 can further be broken down into a first sub-task of determining flight plans for each participant in the vacation, a second sub-task of determining transportation for each participant to an origin airport (or other form of public transportation such as a train station or a subway station), a third sub-task of determining transportation for each participant from a destination airport, as well as a fourth sub-task of determining lodging accommodations for each participant. Further, responsive to determining the plurality of sub-tasks, the agent adaptation system 100 can provide each of the plurality of sub-tasks to a task-specific agent layer (e.g., the task-specific agent layer 423, the task-specific agent layer 424, the task-specific agent layer 426) to cause the task-specific agent layer to perform the sub-task (e.g., by causing a corresponding task-adapter layer to generate a semantic instruction including a command executable by the task-specific agent layer to enable the task-specific agent layer to perform the task.

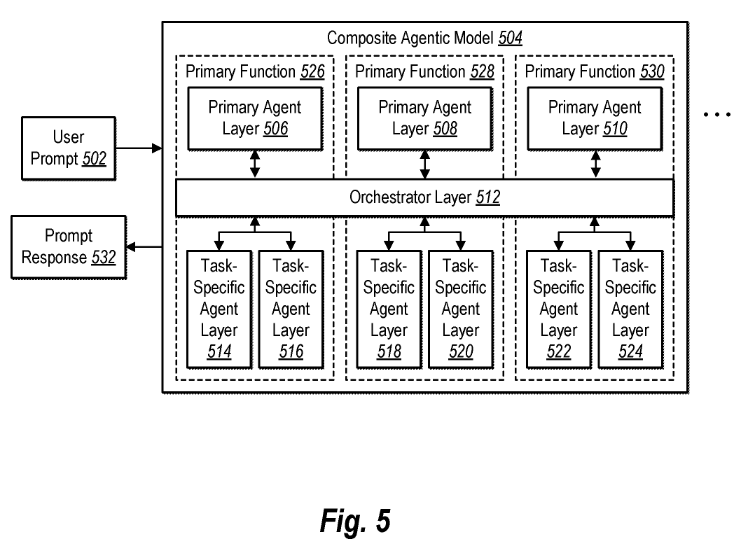

In some embodiments, the agent adaptation system 100 can utilize a composite agentic model. For instance, the agent adaptation system 100 can implement a composite agentic model that includes multiple agents tailored to respective functions. FIG. 5 illustrates the agent adaptation system 100 utilizing a composite agentic model to orchestrate task completion for a user account according to one or more primary functions in accordance with one or more embodiments.

As illustrated in FIG. 5, in some embodiments, the agent adaptation system 100 can cause a composite agentic model 504 to receive a user prompt 502. As used herein, the term “composite agentic model” can refer to a model that includes a plurality of primary agent layers, each specialized for its own function type. For example, the composite agentic model can facilitate execution of tasks within a user prompt according to a primary function of a primary agent layer within the composite agentic model. Indeed, the agent adaptation system 100 can generate or otherwise train each primary agent layer according to a primary function or objective.

Further, as used herein, the term “primary function” can refer to a specialized capability of a primary agent layer specific to a particular domain of tasks (e.g., where a primary function can include a set of tasks executable within a shared domain). Each primary agent layer within a composite agentic model can be specialized for executing tasks within its own respective primary function. Example primary functions include optimization of task performance for a user account, understanding a prompt from a user account, listening to inputs from a user account, assisting a user account in performing tasks within a prompt, personalizing a response to a user prompt, among others. Indeed, the agent adaptation system 100 can orchestrate or otherwise layer one or more primary agent layers of a composite agentic model according to a primary function of each primary agent layer.

As shown in FIG. 5, the agent adaptation system 100 can receive the user prompt 502, determine one or more tasks from the user prompt, and distribute the one or more tasks to a primary agent layer 506, a primary agent layer 508, and/or a primary agent layer 510. Indeed, in some embodiments, the agent adaptation system 100 can utilize an orchestrator layer 512 to determine how to distribute one or more tasks from the user prompt 502. For instance, the agent adaptation system 100 can determine tasks corresponding to various primary functions and can distribute the tasks to respective primary agent layers. In some cases, the agent adaptation system 100 uses the orchestrator layer 512 to process and dissect the user prompt 502, extract one or more tasks from the user prompt 502, and determine one or more primary agent layers for executing tasks. For instance, the agent adaptation system 100 utilizes primary agent layer 506 to execute tasks for one primary function and utilizes primary agent layer 508 to execute tasks for another primary function. Indeed, in some embodiments, the agent adaptation system 100 can utilize the composite agentic model 504 to determine a task from the user prompt 502 and determine to provide the task to the primary agent layer 506 according to the primary function 526 of the primary agent layer 506.

Moreover, the agent adaptation system 100 can generate, train, or otherwise determine a plurality of primary agent layers according to a plurality of primary functions. For example, the agent adaptation system 100 can generate a primary agent layer 508 according to a primary function 528. Additionally, the agent adaptation system 100 can generate a primary agent layer 510 according to a primary function 530. Indeed, as indicated by FIG. 5, the agent adaptation system 100 can determine additional primary agent layers within the composite agentic model 504 according to additional primary functions.

Further, as shown by FIG. 5, the agent adaptation system 100 can utilize the orchestrator layer 512 and/or the primary agent layer to determine a task-specific agent layer 514 to execute a task. Indeed, the agent adaptation system 100 can determine the task-specific agent layer according to the primary function 526 of the primary agent layer 506 (e.g., where the task falls within the task type of the primary function).

Moreover, as shown in FIG. 5, the agent adaptation system 100 can generate, train, or otherwise determine a plurality of groups of task-specific agent layers for each of the plurality of primary agent layers within the composite agentic model 504. For example, the agent adaptation system 100 can generate the task-specific agent layer 514 and a task-specific agent layer 516 (e.g., a first group of task-specific agent layers) for the primary agent layer 506 according to the primary function 526 of the primary agent layer 506. Moreover, the agent adaptation system 100 can generate a task-specific agent layer 518 and a task-specific agent layer 520 (e.g., a second group of task-specific agent layers) for the primary agent layer 508 according to the primary function 528 of the primary agent layer 508. Additionally, the agent adaptation system 100 can generate a task-specific agent layer 522 and a task-specific agent layer 524 (e.g., a third group of task-specific agent layers) for the primary agent layer 510 according to the primary function 530 of the primary agent layer 510.

Further, the agent adaptation system 100 can determine to utilize multiple primary agent layers (and their corresponding groups of task-specific agent layers) iteratively (or in parallel) to complete one or more tasks within a user prompt 502. For example, the agent adaptation system 100 can receive the user prompt 502 as an audio message (e.g., an auditory channel). Based on determining the prompt 502 is an audio message, the agent adaptation system 100 can determine the primary function 526 of listening, and utilize a primary agent layer that corresponds to the primary function to ensure that the agent adaptation system 100 correctly receives the user prompt 502. Specifically, the agent adaptation system 100 can determine to utilize the task-specific agent layer 514 to capture and preprocess the audio message (e.g., the agent adaptation system 100 can determine a domain indicated by the user prompt 502 and determine the first task-specific agent layer according to the domain as well as the primary function 526). Based on capturing and pre-processing the user prompt 502, the agent adaptation system 100 can determine to utilize the task-specific agent layer 516 to perform tasks such as feature extraction, language modeling, and/or decoding on the captured and pre-processed data.

Based on determining the user prompt 502, the agent adaptation system 100 can determine that the user prompt 502 is requesting assistance for a user account in a task, such as booking a flight. The agent adaptation system 100 can determine the primary function 528 of assisting, and utilize the primary agent layer 508 to assist the user account in accomplishing the task. For example, the agent adaptation system 100 can determine to utilize the task-specific agent layer 518 to determine a flight for the user account. Based on determining the flight for the user account, the agent adaptation system 100 can determine to utilize the task-specific agent layer 520 to confirm (e.g., book or otherwise purchase) the flight for the user account.

In parallel to the primary function 528 of assisting, the agent adaptation system 100 can determine the primary function 530 is personalizing for a user account. Accordingly, the agent adaptation system 100 can utilize the primary agent layer 510 in tandem with the primary agent layer 508 to ensure that the assistance rendered through the primary agent layer 508 is personalized by the primary agent layer 510. For example, when utilizing the task-specific agent layer 518 to determine the flight for the user account, the agent adaptation system 100 can simultaneously utilize the task-specific agent layer 522 to provide personalized data related to the task and the user account to the task-specific agent layer 518, such as airline preferences and/or seating preferences. Additionally, when utilizing the task-specific agent layer 520 to confirm the flight, the agent adaptation system 100 can simultaneously utilize the task-specific agent layer 524 to personalize the process of confirming the flight, such as by determining a payment method to utilize and/or to subsidize the confirmation process (e.g., by using accumulated resources, such as miles, associated with the user account).

Based on utilizing the primary agent layer 506, the primary agent layer 508, and/or the primary agent layer 510 to complete one or more tasks associated with the user prompt 502, the agent adaptation system 100 can generate a prompt response 532 for the user account. The agent adaptation system 100 can include one or more descriptions of tasks associated with the user prompt 502 in the prompt response 532, as well as one or more status updates for each of the one or more tasks.

Further, in some embodiments, the agent adaptation system 100 can generate, determine, or otherwise train an orchestrator layer for each primary agent layer based at least in part on the purpose of each primary agent layer. Additionally, the agent adaptation system 100 can incorporate a function of the primary agent layer into a synthetic generation framework to generate, train, or otherwise determine a task adapter layer for a task-specific agent layer. Additionally, in one or more embodiments, the agent adaptation system 100 can utilize a task-specific agent layer that corresponds to a different primary agent layer and/or primary function (e.g., as opposed to utilizing a task-specific agent layer siloed to a primary agent layer according to the primary function of the primary agent layer) to accomplish a task.

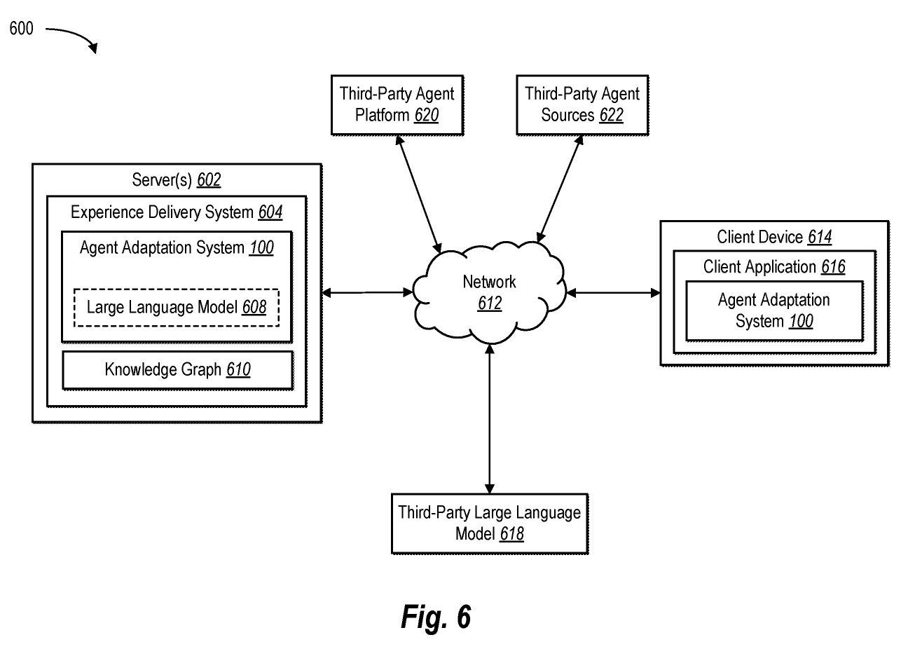

FIG. 6 illustrates a schematic diagram of an exemplary system environment (“environment”) 600 in which an agent adaptation system 100 operates. As illustrated in FIG. 6, the environment 600 includes server(s) 602, a network 612, a client device 614, a third-party large language model 618, a third-party agent platform 620, and third-party services 622.

Although the environment 600 of FIG. 6 is depicted as having a particular number of components, the environment 600 is capable of having any number of additional or alternative components (e.g., any number of server devices, client devices, third-party servers, or other components in communication with the agent adaptation system 100 via the network 612). Similarly, although FIG. 6 illustrates a particular arrangement of the server(s) 602, the network 612, the client device 614, the third-party large language model 618, the third-party agent platform 620 and the third-party services 622, various additional arrangements are possible.

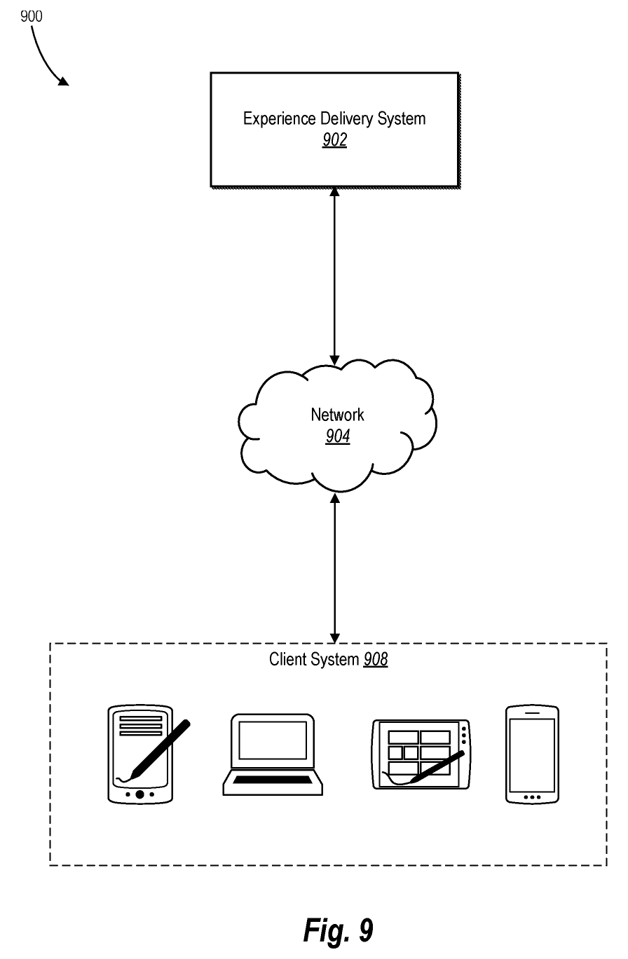

The server(s) 602, the network 612, the client device 614, the third-party large language model 618, the third-party agent platform 620 and the third-party services 622, are communicatively coupled with each other either directly or indirectly (e.g., through the network 612 discussed in greater detail below in relation to FIG. 9. Moreover, the server(s) 602, the client device 614, the third-party large language model 618, the third-party agent platform 620 and the third-party services 622, each include one of a variety of computing devices (including one or more computing devices as discussed in greater detail with relation to FIG. 9).

As mentioned above, the environment 600 includes the server(s) 602. In one or more embodiments, the server(s) 602 generates, stores, receives, and/or transmits data, including user prompts, task prompts, task responses, task item instructions, task statuses, and/or user responses. In one or more embodiments, the server(s) 602 comprises a data server. In some implementations, the server(s) 602 comprises a communication server or a web-hosting server.

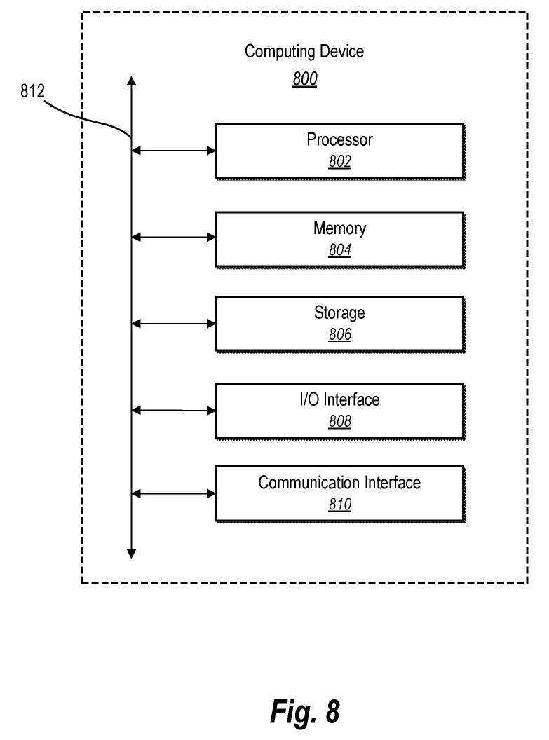

As mentioned above, the environment 600 includes a client device 614. The client device 614 can be one of a variety of computing devices, including a smartphone, a tablet, a smart television, a desktop computer, a laptop computer, a virtual reality device, an augmented reality device, or another computing device as described in relation to FIGS. 8-9. The client device 614 can communicate with the server(s) 602 via the network 612. For example, the client device 614 can receive user input from a user interacting with the client device 614 (e.g., via a client application 616) to, for instance, access, generate, modify, or share a content item, to collaborate with a co-user of a different client device, or to select a user interface element. In addition, the agent adaptation system 100 on the server(s) 602 can receive information relating to various interactions with content items and/or user interface elements based on the input received by the client device 614.

As shown, the client device 614 can include a client application 616. In particular, the client application 616 may be a web application, a native application installed on the client device 614 (e.g., a mobile application, a desktop application, etc.), or a cloud-based application where all or part of the functionality performed by the server(s) 602. Based on instructions from the client application 616, the client device 614 can present or display information, including a user response the agent adaptation system 100 generates according to a user prompt.

In one or more embodiments, the experience delivery system 604 provides functionality that facilitates a communication between participants. For example, in some implementations, the experience delivery system 604 provides functionality for transmitting and/or recording a communication between users. In some embodiments, the experience delivery system 604 provides functionality that more specifically assists one user in communicating with another user. For instance, the experience delivery system 604 can provide functionality that enables a device of one of the users (e.g., a device used to transmit the communication or a separate, supplementary device) to display information relevant to the communication (e.g., to display information for the other user(s) participating in the communication, such as identifying information or account information).

In some embodiments, the experience delivery system 604 can include a knowledge graph 610 of the experience delivery system 604. For example, the knowledge graph can include nodes representing users within the experience delivery system 604 and edges connecting the nodes that represent relationships between the users of the experience delivery system 604. The knowledge graph can include demographic data as well as other user data that can be used to generate customized responses and actions by the experience management system.

Additionally, the server(s) 602 include the agent adaptation system 100. In one or more embodiments, the agent adaptation system 100, via the server(s) 602, provides a personalized user experience for a third-party service. For instance, in some cases, the agent adaptation system 100, via the server(s) 602, receives a user prompt. The agent adaptation system 100 can determine tasks according to the user prompt, and utilize a knowledge graph to generate a user response customized to the user. The agent adaptation system 100 can utilize the knowledge graph to complete the tasks from the user prompt in a way that is uniquely catered to the user. In some cases, via the server(s) 602, the agent adaptation system 100 generates a user response to a user prompt according to a task item status received from an internal platform agent and/or a third-party agent platform 620. Additionally, in some embodiments, the agent adaptation system 100 can include an internal large language model 608 that is native to, housed or hosted on, and/or otherwise maintained by the agent adaptation system 100.

Moreover, the environment 600 can include a third-party large language model 618. A third-party server can host the third-party large language model 618 for access by the agent adaptation system 100 (e.g., as an alternative to the server(s) 602 hosting or housing the internal large language model 608). For example, the third-party large language model 618 can be external to the agent adaptation system 100, but the agent adaptation system 100 can nevertheless access and utilize the third-party large language model 618 via one or more plugins, APIs, or other network based protocols.

As illustrated, the environment 600 can include a third-party agent platform 620. A third-party server can host the third-party agent platform 620 for access by the agent adaptation system 100. For example, the third-party agent platform 620 can be external to the agent adaptation system 100, but the agent adaptation system 100 can nevertheless access and utilize the third-party agent platform 620 via one or more plugins, APIs, or other network-based access protocols.

Additionally, the environment 600 can include third-party services 622. A third-party server can host the third-party services 622 for access by the agent adaptation system 100. For example, the third-party services 622 can be external to the agent adaptation system 100, but the agent adaptation system 100 can nevertheless access and utilize the third-party services 622 via one or more plugins, APIs, or other network-based access protocols.

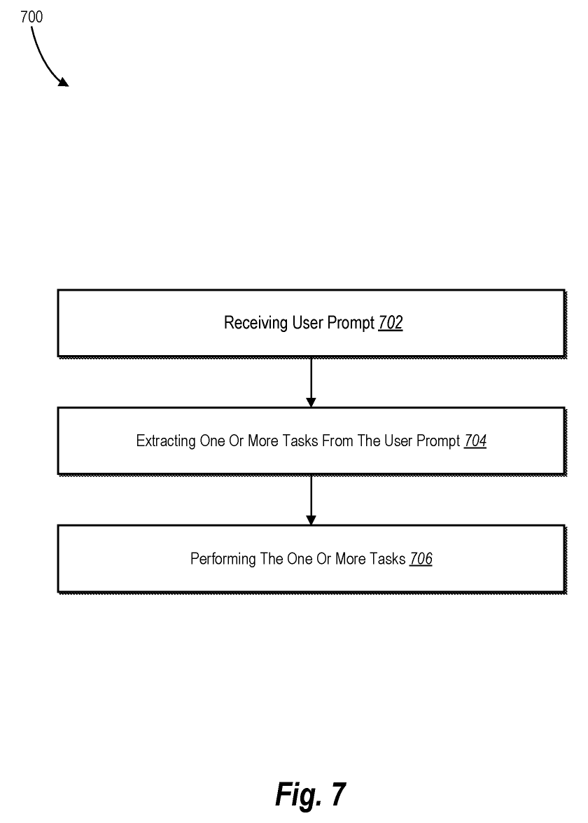

FIGS. 1-6, the corresponding text, and the examples provide a number of different methods, systems, devices, and non-transitory computer-readable media of the agent adaptation system 100. In addition to the foregoing, one or more embodiments can also be described in terms of flowcharts comprising acts for accomplishing a particular result, as shown in FIG. 7. The method shown in FIG. 7 may be performed with more or fewer acts than shown. Further, the acts of FIG. 7 may be performed as shown. Additionally, the acts described herein may be repeated or performed in parallel with one or another or in parallel with different instances of the same or similar acts.

While FIG. 7 illustrates acts according to certain implementations, alternative implementations may omit, add to, reorder and/or modify any of the acts shown in FIG. 7. The acts of FIG. 7 can be performed as part of a computer-implemented method. Alternatively, a non-transitory computer-readable medium can comprise instructions (e.g., stored thereon) that, when implemented by one or more processors, cause a computing device to perform the acts of FIG. 7. In still further embodiments, a system can perform the acts of FIG. 7.

As illustrated in in FIG. 7, a series of acts 700 can include an act 702 of receiving a user prompt. In particular, the act 702 can include receiving, by an agentic model comprising an orchestrator layer and one or more task-specific agent layers, a user prompt from a client device. In addition, the series of acts 700 can include an act 704 of extracting one or more tasks from the user prompt. In particular, the act 704 can include extracting, from the user prompt using the orchestrator layer of the agentic model, one or more tasks executable using a task-specific agent layer of the one or more task-specific agent layers within the agentic model. Moreover, the series of acts 700 can include an act 706 of performing the one or more tasks. In particular, the act 706 can include performing the one or more tasks by executing, using the task-specific agent layer, the command of the semantic instruction informed by the data specific to the domain and specific to the one or more tasks.

Additionally, in some embodiments, the series of acts 700 can include generating, for augmenting the large language model, a triple-layer augmentation model including a demographic layer informing the large language model on the demographic data, an industry layer informing the large language model on industry data, and the task adapter layer informing the large language model on domain data. Further, the series of acts 700 can include fine-tuning the large language model utilizing the triple-layer augmentation model.

Further, in one or more embodiments, the series of acts 700 can include generating a fine-tuning dataset utilizing a synthetic data generation framework that modifies sample data for domain-specific knowledge. In addition, the series of acts 700 can include utilizing the fine-tuning dataset to fine-tune the task adapter layer to perform the one or more tasks specific to the domain.

Moreover, in some embodiments, the series of acts 700 can include determining the domain for the task adapter layer as a brand entity within an experience delivery system.

Additionally, in one or more embodiments, the series of acts 700 can include selecting, from the one or more task-specific agent layers, the task-specific agent layer according to the one or more tasks.

In addition, in some embodiments, the series of acts 700 can include delimiting, from the user prompt using the orchestrator layer of the agentic model, a plurality of task types executable by respective task adapter layers. Additionally, the series of acts 700 can include orchestrating execution of the tasks within the plurality of task types using the orchestrator layer to distribute tasks to the respective task adapter layers.

Further, in some embodiments, the agentic model further comprises a primary agent layer linked to the orchestrator layer. Additionally, in one or more embodiments, the orchestrator layer can be linked to the one or more task-specific agent layers. Moreover, in some embodiments, the primary agent layer interfaces with the client device for receiving user prompts and providing responses to the user prompts.

Moreover, in one or more embodiments, the agentic model is a composite agentic model comprising a plurality of primary agent layers linked to the orchestrator layer, wherein each of the primary agent layers are configured to perform a corresponding primary function. Additionally, in some embodiments, the orchestrator layer is linked to the one or more task-specific agent layers. Further, in one or more embodiments, the plurality of primary agent layers interface with the client device for receiving user prompts and providing responses to the user prompts.

Embodiments of the present disclosure can comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure can be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure can also be practiced in distributed system environments where local and remote computer systems, which are linked (either by hardwired data links, wireless data links, or by a combination of hardwired and wireless data links) through a network, both perform tasks. In a distributed system environment, program modules can be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of computing device 800 that can be configured to perform one or more of the processes described above. One will appreciate that one or more computing devices, such as the computing device 800, can implement the various devices of the environment of FIG. 6. As shown by FIG. 8, the computing device 800 can comprise a processor 802, a memory 804, a storage device 806, an I/O interface 808, and a communication interface 810, which can be communicatively coupled by way of a communication infrastructure 812. While a computing device 800 is shown in FIG. 8, the components illustrated in FIG. 8 are not intended to be limiting. Additional or alternative components can be used in other embodiments. Furthermore, in certain embodiments, the computing device 800 can include fewer components than those shown in FIG. 8. Components of the computing device 800 shown in FIG. 8 will now be described in additional detail.

In one or more embodiments, the processor 802 includes hardware for executing instructions, such as those making up a computer program. As an example, and not by way of limitation, to execute instructions, the processor 802 can retrieve (or fetch) the instructions from an internal register, an internal cache, the memory 804, or the storage device 806 and decode and execute them. In one or more embodiments, the processor 802 can include one or more internal caches for data, instructions, or addresses. As an example, and not by way of limitation, the processor 802 can include one or more instruction caches, one or more data caches, and one or more translation lookaside buffers (TLBs). Instructions in the instruction caches can be copies of instructions in the memory 804 or the storage device 806.

The memory 804 can be used for storing data, metadata, and programs for execution by the processor(s). The memory 804 can include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 can be internal or distributed memory.

The storage device 806 includes storage for storing data or instructions. As an example, and not by way of limitation, storage device 806 can comprise a non-transitory storage medium described above. The storage device 806 can include a hard disk drive (HDD), a floppy disk drive, flash memory, an optical disc, a magneto-optical disc, magnetic tape, or a Universal Serial Bus (USB) drive or a combination of two or more of these. The storage device 806 can include removable or non-removable (or fixed) media, where appropriate. The storage device 806 can be internal or external to the computing device 800. In one or more embodiments, the storage device 806 is non-volatile, solid-state memory. In other embodiments, the storage device 806 includes read-only memory (ROM). Where appropriate, this ROM can be mask programmed ROM, programmable ROM (PROM), erasable PROM (EPROM), electrically erasable PROM (EEPROM), electrically alterable ROM (EAROM), or flash memory or a combination of two or more of these.

The I/O interface 808 allows a user to provide input to, receive output from, and otherwise transfer data to and receive data from computing device 800. The I/O interface 808 can include a mouse, a keypad or a keyboard, a touch screen, a camera, an optical scanner, network interface, modem, other known I/O devices or a combination of such I/O interfaces. The I/O interface 808 can include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data can be representative of one or more graphical user interfaces and/or any other graphical content as can serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example, and not by way of limitation, the communication interface 810 can include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 810 can facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, the communication interface 810 can facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 810 can facilitate communications various communication protocols. Examples of communication protocols that can be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 812 can include hardware, software, or both that couples components of the computing device 800 to each other. As an example and not by way of limitation, the communication infrastructure 812 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 9 illustrates an example network environment 900. Network environment 900 includes a client system 908, and an experience delivery system 902 (e.g., the experience delivery system 604 of FIG. 6) connected to each other by a network 904. Although FIG. 9 illustrates a particular arrangement of client system 908, experience delivery system 902, and network 904, this disclosure contemplates any suitable arrangement of client system 908, experience delivery system 902, and network 904. As an example, and not by way of limitation, two or more of client system 908, and experience delivery system 902 can be connected to each other directly, bypassing network 904. As another example, two or more of client system 908 and experience delivery system 902 can be physically or logically co-located with each other in whole, or in part. Moreover, although FIG. 9 illustrates a particular number of client systems 908, experience delivery system 902, and network 904, this disclosure contemplates any suitable number of client systems 908, experience delivery system 902, and network 904. As an example, and not by way of limitation, network environment 900 can include multiple client systems 908, experience delivery system 902, and network 904.

This disclosure contemplates any suitable network 904. As an example and not by way of limitation, one or more portions of network 904 can include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 904 can include one or more networks.

Links can connect client system 908, and experience delivery system 902 to network 904 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links can differ in one or more respects from one or more second links.

In particular embodiments, client system 908 can be an electronic device including hardware, software, or embedded logic components or a combination of two or more such components and capable of carrying out the appropriate functionalities implemented or supported by client system 908. As an example, and not by way of limitation, a client system 908 can include any of the computing devices discussed above in relation to FIG. 9. A client system 908 can enable a network user at client system 908 to access network 904. A client system 908 can enable its user to communicate with other users at other client devices or systems.

In particular embodiments, client system 908 can include a web browser, such as MICROSOFT EDGE, GOOGLE CHROME, or MOZILLA FIREFOX, and can have one or more add-ons, plug-ins, or other extensions, such as TOOLBAR or YAHOO TOOLBAR. A user at client system 908 can enter a Uniform Resource Locator (URL) or other address directing the web browser to a particular server (such as server, or a server associated with a third-party system), and the web browser can generate a Hyper Text Transfer Protocol (HTTP) request and communicate the HTTP request to server. The server can accept the HTTP request and communicate to client system 908 one or more Hyper Text Markup Language (HTML) files responsive to the HTTP request. Client system 908 can render a webpage based on the HTML files from the server for presentation to the user. This disclosure contemplates any suitable webpage files. As an example, and not by way of limitation, webpages can render from HTML files, Extensible Hyper Text Markup Language (XHTML) files, or Extensible Markup Language (XML) files, according to particular needs. Such pages can also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser can use to render the webpage) and vice versa, where appropriate.

In particular embodiments, experience delivery system 902 can include a variety of servers, sub-systems, programs, modules, logs, and data stores. In particular embodiments, experience delivery system 902 can include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. experience delivery system 902 can also include suitable components such as network interfaces, security mechanisms, load balancers, failover servers, management-and-network-operations consoles, other suitable components, or any suitable combination thereof.

In particular embodiments, experience delivery system 902 can include one or more user-profile stores for storing user profiles. A user profile can include, for example, biographic information, demographic information, behavioral information, social information, or other types of descriptive information, such as work experience, educational history, hobbies or preferences, interests, affinities, or location. Interest information can include interests related to one or more categories. Categories can be general or specific.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method, comprising:
receiving, by an agentic model comprising an orchestrator layer and one or more task-specific agent layers, a user prompt from a client device;
extracting, from the user prompt using the orchestrator layer of the agentic model, one or more tasks executable using a task-specific agent layer of the one or more task-specific agent layers within the agentic model;
generating, by processing the one or more tasks using a large language model augmented by a task adapter layer that is linked to the task-specific agent layer, a semantic instruction comprising data specific to a domain and specific to the one or more tasks and further comprising a command executable by the task-specific agent layer to perform the one or more tasks; and
performing the one or more tasks by executing, using the task-specific agent layer, the command of the semantic instruction informed by the data specific to the domain and specific to the one or more tasks.

2. The computer-implemented method of claim 1, further comprising:
generating, for augmenting the large language model, a triple-layer augmentation model comprising a demographic layer informing the large language model on demographic data, an industry layer informing the large language model on industry data, and the task adapter layer informing the large language model on domain data; and
fine-tuning the large language model utilizing the triple-layer augmentation model.

3. The computer-implemented method of claim 2, further comprising:
generating a fine-tuning dataset utilizing a synthetic data generation framework that modifies sample data for domain-specific knowledge; and
utilizing the fine-tuning dataset to fine-tune the task adapter layer to perform the one or more tasks specific to the domain.

4. The computer-implemented method of claim 1, further comprising determining the domain for the task adapter layer as a brand entity within an experience delivery system.

5. The computer-implemented method of claim 1, further comprising selecting, from the one or more task-specific agent layers, the task-specific agent layer according to the one or more tasks.

6. The computer-implemented method of claim 1, further comprising:
delimiting, from the user prompt using the orchestrator layer of the agentic model, a plurality of task types executable by respective task adapter layers; and
orchestrating execution of tasks within the plurality of task types using the orchestrator layer to distribute the tasks to the respective task adapter layers.

7. The computer-implemented method of claim 1, wherein:
the agentic model further comprises a primary agent layer linked to the orchestrator layer;
the orchestrator layer is linked to the one or more task-specific agent layers; and
the primary agent layer interfaces with the client device for receiving user prompts and providing responses to the user prompts.

8. A system comprising:
at least one processor; and
at least one non-transitory computer-readable storage medium storing instructions that, when executed by the at least one processor, cause the system to:
receive, by an agentic model comprising an orchestrator layer and one or more task-specific agent layers, a user prompt from a client device;
extract, from the user prompt using the orchestrator layer of the agentic model, one or more tasks executable using a task-specific agent layer of the one or more task-specific agent layers within the agentic model;
generate, by processing the one or more tasks using a large language model augmented by a task adapter layer that is linked to the task-specific agent layer, a semantic instruction comprising data specific to a domain and specific to the one or more tasks and further comprising a command executable by the task-specific agent layer to perform the one or more tasks; and
perform the one or more tasks by executing, using the task-specific agent layer, the command of the semantic instruction informed by the data specific to the domain and specific to the one or more tasks.

9. The system of claim 8, further comprising instructions that, when executed by the at least one processor, cause the system to:
generate, for augmenting the large language model, a triple-layer augmentation model comprising a demographic layer informing the large language model on demographic data, an industry layer informing the large language model on industry data, and the task adapter layer informing the large language model on domain data; and
fine-tune the large language model utilizing the triple-layer augmentation model.

10. The system of claim 8, further comprising instructions that, when executed by the at least one processor, cause the system to:
generate a fine-tuning dataset utilizing a synthetic data generation framework that modifies sample data for domain-specific knowledge; and
utilize the fine-tuning dataset to fine-tune the task adapter layer to perform the one or more tasks specific to the domain.

11. The system of claim 8, further comprising instructions that, when executed by the at least one processor, cause the system to determine the domain for the task adapter layer as a brand entity within an experience delivery system.

12. The system of claim 8, further comprising instructions that, when executed by the at least one processor, cause the system to select, from the one or more task-specific agent layers, the task-specific agent layer according to the one or more tasks.

13. The system of claim 8, further comprising instructions that, when executed by the at least one processor, cause the system to:
delimit, from the user prompt using the orchestrator layer of the agentic model, a plurality of task types executable by respective task adapter layers; and
orchestrate execution of tasks within the plurality of task types using the orchestrator layer to distribute the tasks to the respective task adapter layers.

14. The system of claim 8, wherein:
the agentic model is a composite agentic model comprising a plurality of primary agent layers linked to the orchestrator layer, wherein each of the plurality of primary agent layers are configured to perform a corresponding primary function;
the orchestrator layer is linked to the one or more task-specific agent layers; and
the plurality of primary agent layers interface with the client device for receiving user prompts and providing responses to the user prompts.

15. A non-transitory computer-readable medium storing instructions thereon that, when executed by at least one processor, cause a computing device to:
receive, by an agentic model comprising an orchestrator layer and one or more task-specific agent layers, a user prompt from a client device;
extract, from the user prompt using the orchestrator layer of the agentic model, one or more tasks executable using a task-specific agent layer of the one or more task-specific agent layers within the agentic model;
generate, by processing the one or more tasks using a large language model augmented by a task adapter layer that is linked to the task-specific agent layer, a semantic instruction comprising data specific to a domain and specific to the one or more tasks and further comprising a command executable by the task-specific agent layer to perform the one or more tasks; and
perform the one or more tasks by executing, using the task-specific agent layer, the command of the semantic instruction informed by the data specific to the domain and specific to the one or more tasks.

16. The non-transitory computer-readable medium of claim 15, further comprising instructions that, when executed by the at least one processor, cause the computing device to:
generate, for augmenting the large language model, a triple-layer augmentation model comprising a demographic layer informing the large language model on demographic data, an industry layer informing the large language model on industry data, and the task adapter layer informing the large language model on domain data; and
fine-tune the large language model utilizing the triple-layer augmentation model.

17. The non-transitory computer-readable medium of claim 15, further comprising instructions that, when executed by the at least one processor, cause the computing device to:
generate a fine-tuning dataset utilizing a synthetic data generation framework that modifies sample data for domain-specific knowledge; and
utilize the fine-tuning dataset to fine-tune the task adapter layer to perform the one or more tasks specific to the domain.

18. The non-transitory computer-readable medium of claim 15, further comprising instructions that, when executed by the at least one processor, cause the computing device to determine the domain for the task adapter layer as a brand entity within an experience delivery system.

19. The non-transitory computer-readable medium of claim 15, further comprising instructions that, when executed by the at least one processor, cause the computing device to select, from the one or more task-specific agent layers, the task-specific agent layer according to the one or more tasks.

20. The non-transitory computer-readable medium of claim 15, further comprising instructions that, when executed by the at least one processor, cause the computing device to:
delimit, from the user prompt using the orchestrator layer of the agentic model, a plurality of task types executable by respective task adapter layers; and
orchestrate execution of tasks within the plurality of task types using the orchestrator layer to distribute the tasks to the respective task adapter layers.
